(19) United States
(12) Patent Application Publication
(10) Pub. No.: US 2005/0051723 A1
(43) Pub. Date: Mar. 10, 2005

(54) Examination systems for biological samples

(76) Inventors: Bradley D. Neagle, Ann Arbor, MI (US); Kirk S. Schroeder, Ann Arbor, MI (US); John H. Seldin, Ann Arbor, MI (US); Thomas L. Griffin, Farmington Hills, MI (US); Alan J. Riggs, Ann Arbor, MI (US)

Correspondence Address: KOLISCH HARTWELL, P.C., 520 S.W. YAMHILL STREET, SUITE 200, PORTLAND, OR, 97204, US

(21) Appl. No.: 10/898,012

(22) Filed: Jul. 23, 2004

Related U.S. Application Data
(60) Provisional application No. 60/489,439, filed on Jul. 23, 2003.

(51) Int. Cl. G01N 23/00

(52) U.S. Cl. 250/306

(57) ABSTRACT

Examination systems, including methods and apparatus, for automated assay of biological samples, such as live cells.

### CROSS-REFERENCE TO PRIORITY APPLICATION

This application is based upon and claims the benefit under 35 U.S.C. § 119(e) of U.S. Provisional Patent Application Ser. No. 60/489,439, filed Jul. 23, 2003, which is incorporated herein by reference in its entirety for all purposes.

### INTRODUCTION

Many experimental biology laboratories depend on cultured cells and tissues to conduct daily experiments. Cell culture typically is conducted in disposable plastic vessels that are placed in CO₂ incubators. These vessels may be used simply to propagate or maintain cells, and/or to prepare cells for assays that often are conducted in the same and/or different vessels, outside an incubator.

The results of cell culture assays can be distorted by unintended changes in cell physiology due to inconsistencies in the underlying cell culture. The primary tool used by technicians to evaluate cell health is the phase-contrast microscope. Experienced technicians can recognize subtle changes in cell morphology, growth patterns, and growth rates that signal problems with a particular culture.

Unfortunately, in the modern laboratory environment, there are many impediments to the proper monitoring of cultured cells. For example, it may be impractical and cost prohibitive to conduct around-the-clock (e.g., every 2-4. hours) manual examination of cell cultures. In addition, manual examination provides only a subjective assessment, with no lasting visual record or archive. In a busy laboratory, signs of problems with cell cultures often are missed by technicians who do not always have the time or experience to diagnose these problems. This can have a severe detrimental impact on the quality of data generated by cell-based assays.

Despite the problems associated with inconsistent cell culture, there has been an increased focus in modern drug discovery on the use of assay technologies using living cells for the assessment of biological function of new chemical entities. In parallel, there has been a renewed interest in the development of microscope-based imaging platforms for assessing biological function. This interest has been spurred on by improvements in instrumentation and the development of vital fluorochromes, such as green fluorescent protein (GFP),that may be less toxic than traditional fluorescent probes. In addition, vital fluorochromes may allow researchers to target a fluorescent marker to specific organelles within the cell.

Live-cell microscopy places some demands on the design of the assay platform. Most cell culture techniques require the use of environmentally controlled chambers, generally termed incubators, to maintain the temperature, humidity, and pH of cell samples. Typically, pH is maintained by providing a 5 to 10% CO₂ atmosphere in conjunction with a bicarbonate buffering media. However, most microscopy takes place outside the confines of this controlled environment, which places restrictions on the length of time that living cell cultures can be analyzed and still remain healthy and viable.

Depending on the requirements of particular assays, various approaches have been attempted to accommodate the use of cells in drug development efforts. One approach is to “fix” the cells, a process that may use harsh chemicals such as formaldehyde. The formaldehyde may cross-link proteins in the cell, stabilizing the remaining contents of the cell (such as lipids and carbohydrates), often without changing the optical characteristics of dyes, such as cellular stains or fluorescent probes. The cells then may be imaged following the fixing step. A fixing technique limits the biological observation to what had occurred at the time of fixing and therefore is a single-time point, invasive approach.

However, it is often desirable to gather a kinetic sequence of cell images or other data. If the same sample of cells is to be monitored over time, the measurement technique employed needs to be non-invasive, that is, not substantially altering the parameter or function being measured. Non-invasive measurements can be achieved in some instances by limiting the assay time (e.g., less than about sixty minutes), such that the cells remain viable outside of an incubator for the duration of the experiment. With this approach, the cells often are placed in phosphate-buffered saline (PBS) (or another suitable buffer), which will maintain pH in normal ambient atmospheric conditions (i.e., does not require high CO₂). With an appropriate selection of buffer and assay procedures, cells may remain functional and viable in ambient conditions for a few hours. This is a common approach for commercially available live-cell assays, such as measurements of intracellular calcium, where the time course of the experiments is between a few minutes and sixty minutes. Similarly, in high-throughput measurements of ion channel activity using live cells, the time course of the assay generally is limited to sixty minutes or less and as such can be performed using PBS outside of an incubator. Alternatively, if information of a longer duration is required, a biological sample can be retrieved from an incubator and placed at a read-out site (e.g., on a microscope platform). Then, the measurement(s) can be performed, and the sample can be returned to the incubator after the measurement(s). For multiple measurements, this procedure can be repeated as often as necessary. However, such an approach may remove, or at least disrupt, the environmental conditions of the sample during the transfer and/or observation time.

### SUMMARY

The present teachings provide examination systems, including methods and apparatus, for automated assay of biological samples, such as live cells.

### BRIEF DESCRIPTION OF THE DRAWINGS

FIG. 1 is a schematic view of an exemplary examination system for assay of biological samples, in accordance with aspects of the present teachings.

FIG. 2 is a schematic view of an exemplary sample reader that may be included in the examination system of FIG. 1, in accordance with aspects of the present teachings.

FIG. 3 is an axonometric view of another exemplary sample reader that may be included in the examination system of FIG. 1, with the view taken generally from in front of and above the sample reader, with the sample reader in a closed, scanning configuration, in accordance with aspects of the present teachings.

FIG. 4 is another axonometric view of the sample reader of FIG. 3, taken generally as in FIG. 3, with the sample reader in an open, loading configuration.

FIG. 5 is yet another axonometric view of the sample reader of FIG. 3, with the view taken generally from behind and above the sample reader, with the sample reader in the loading configuration of FIG. 4.

FIG. 6 is a view of an imaging mechanism and an associated drive mechanism from the sample reader of FIGS. 3-5, with the view taken generally as in FIG. 5.

FIG. 7 is another view of the imaging mechanism and drive mechanism of FIG. 6, taken generally from below these mechanisms.

FIG. 8 is a somewhat schematic view of a cleat mechanism with which at least portions of the imaging mechanism may be secured adjustably to the drive mechanism, in accordance with aspects of the present teachings.

FIG. 9 is a side elevation view of selected portions of the imaging mechanism of FIGS. 6 and 7, with the imaging mechanism positioned to image a sample contained in a culture vessel resting on a sample support, in accordance with aspects of the present teachings.

FIG. 10 is an exemplary screen shot of a window presented by a remote computer and created with data downloaded over a network from a local controller operating the sample reader of FIGS. 3-5, in accordance with aspects of the present teachings.

FIG. 11 is another exemplary screen shot of a window presented by the remote computer of FIG. 10 and created with data downloaded from the local controller, in accordance with aspects of the present teachings.

FIG. 12 is yet another exemplary screen shot of a window presented by the remote computer of FIG. 10 and created with data downloaded from the local controller, in accordance with aspects of the present teachings.

FIG. 13 is a plot of cell confluency data collected over time with an embodiment of an examination system constructed according to aspects of the present teachings.

### DETAILED DESCRIPTION

The present teachings provide examination systems, including methods and apparatus, for automated assay of biological samples, such as live cells. In some embodiments, the examination systems may provide automated assay (examination) of the samples while they are disposed in a controlled environment. The examination systems may include a sample reader and a local controller that operates the sample reader automatically. The sample reader may sense data from the samples, such as images of live cells collected sequentially by scanning. This automated examination may be repeated over time so that the samples are monitored automatically. In some embodiments, the local controller may be configured to be connected to a network (such as a local area network (LAN) or wide area network (WAN)), so that a user may interact with the local controller remotely through an interface such as a graphical interface.

The sample reader may be a module configured to be received in an environmentally controlled chamber, such as inside a tissue culture incubator. Accordingly, the sample reader may have a compact design to minimize its size while maintaining its sample capacity. This compact design may be facilitated by various features, such as a separate controller spaced from the module, an optical detection mechanism employing a folded optical path, a slidable sample support that extends from the module for sample loading, and/or a detection mechanism movable in an area corresponding to a substantial portion of the module footprint.

The examination systems described herein may offer a number of advantages and/or improvements. For example, these examination systems may offer improved sample handling, higher assay reproducibility, increased automation, better assay documentation, remote control of sample monitoring, remote access to sample data, and/or non-invasive inspection, among others. Moreover, these examination systems may provide a convenient approach for generating microscopic imagery of a plurality biological samples over longer time periods (hours to days), without having to remove the samples from a controlled environment and/or without the need for human intervention.

Further aspects of the present teachings are included in the following sections, including, among others, (I) overview of an exemplary examination system; (II) examination apparatus, including (A) sample readers and (B) controllers; (III) biological samples; (IV) assays; and (V) examples.

I. Overview of an Exemplary Examination System

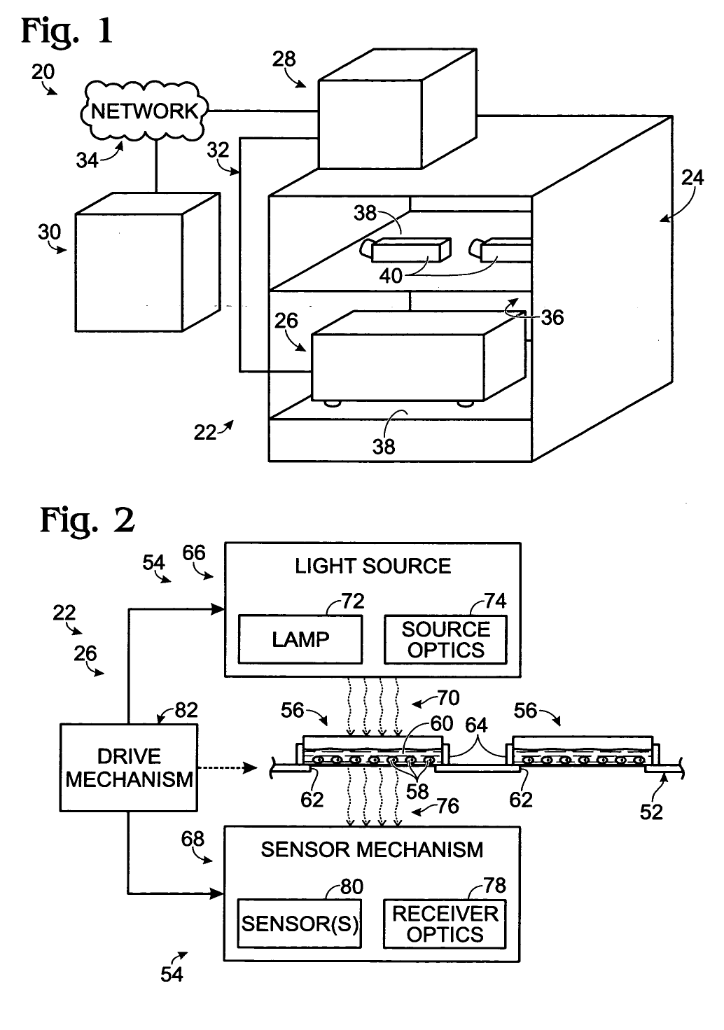

FIG. 1 shows a schematic representation of an exemplary examination system 20 for assay of biological samples. Assay system 20 may include a sample analysis system 22 and an environmental control apparatus 24, among others. The sample analysis system may include a sample reader 26, a local or examination controller 28, and/or a remote computing device 30 (an external or remote controller), among others. The local controller 28 may be in communication with the sample reader, shown at 32, to operate the sample reader automatically. The local controller 28 also may be connected to the remote computing device 30, via a wired/wireless network connection, shown at 34, for remote communication with the local controller 28.

The environmental control apparatus 24 may be configured to provide a controlled environment for sample preparation, incubation, culture, and/or assay, among others. Any suitable environmental conditions may be controlled by this apparatus, including temperature, gas composition, humidity, pressure, and/or the like. For example, the environmental control apparatus may be a tissue culture incubator. The environmental control apparatus may define an environmentally controlled chamber 36 in which the sample reader 26 and/or local controller 28 may be received and enclosed. In some examples, the sample reader may be included in a module configured to be received and enclosed by commercially available tissue culture incubators, in some cases, occupying less than the half the volume of the incubator chamber, so that the chamber may be used for other purposes and/or may receive two or more sample readers. In the present illustration, the sample reader 26 is configured as a module that may be separate from the local controller and/or integrated with this controller. Accordingly, the sample reader (and/or the local controller) may be removably disposed in the chamber 36 or may be integrated into the environmental control apparatus. Alternatively, or in addition, the local controller may be disposed outside of apparatus 24 (and/or chamber 36). Furthermore, the environmental control apparatus 24 may include one or more support structures, such as shelves 38, to support sample reader 26 and/or spaced sample holders, such as culture vessels 40. The sample reader thus may have a low profile, that is, a relatively small vertical height, such as less than half the height of the chamber. In some embodiments, the examination system may not include an environmental control apparatus. In some embodiments, the environmental control apparatus may be included in the examination system so that at least some aspects of operation of this apparatus (such as sensing, monitoring, and/or regulating environmental conditions) can be controlled automatically by the examination system.

FIG. 2 shows a schematic representation of selected portions of the examination system 22, particularly sample reader 26. Sample reader 26 may include a sample support 52 disposed in proximity to a detection mechanism 54. The sample support 52 may be configured to receive a plurality of sample containers, such as dishes 56 holding samples, such as cells 58 and/or fluid 60, and to hold the sample containers as their contents are sensed by the detection mechanism 54. Accordingly, the sample support 52 may include one or more windows 62 (such as openings or transparent regions, among others) aligned with and/or overlapping each sample container 56. The sample support 52 also may include receiver structures, such as retainers 64 (e.g., pins, clips, or clamps, among others), that restrict movement of the sample containers 56, particularly relative to the sample support and/or each other.

The detection mechanism 54 may include a light source 66 and/or a sensor mechanism 68. The light source may direct light, shown at 70, to sample support 52, sample container 56, and/or cells 58. Accordingly, the light source may include a lamp 72 and associated source optics 74. The sensor mechanism 68 may receive the light, shown at 76, after any interaction with the sample support 52, sample container 56, cells 58, and/or fluid 60. The sensor mechanism may include receiver optics 78 and one or more sensors 80 to sense the light. In some examples, a single sensor may be used, for example, to scan the sample. In the same and/or other examples, a plurality of sensors may be used, for example, disposed in an array to sense images of the sample. In some examples, the light source may be omitted (such as for measurement from chemiluminescent and/or radioactive samples) and/or the sensor mechanism may be configured to sense signals other than light (such as radioactive (e.g., alpha and beta) particles).

The sample reader 26 also may include a drive mechanism 82 coupled to the sample support 52 and/or the detection mechanism 54, to drive movement of either or both of these mechanisms. The drive mechanism may be configured to drive relative movement of the sample support and the detection mechanism to allow portions of a single biological sample and/or an array of biological samples held by the sample support 52 to be sensed sequentially or at overlapping times. In some embodiments, the sample support 52 or the detection mechanism 54 (or both) may be configured to remain stationary during examination of a set of samples. In some embodiments, both the sample support and detection mechanism (or a portion(s) thereof) may move relative to a stationary frame during examination of a set of samples.

Local controller 28 (see FIG. 1) may be in communication with the drive mechanism 82, the detection mechanism 54, and/or one or more remote computing devices. The local controller may be configured to operate one or both of the drive and detection mechanisms automatically. The local controller also may be instructed by one or more users (particularly an authorized user(s)) to perform examination operations automatically according to selected times, positions within a sample array or set of sample containers, and/or detection modes, among others. Users may interact with the local controller locally and/or remotely (such as from remote computing device (e.g., a personal computer) through a network connection), to provide inputs to the local controller (such as to configure examination) and/or to receive outputs (such as sample data) from the local controller 28. In some examples, the remote computing device may include any personal computer with Internet access.

II. Examination Apparatus

The examination systems of the present teachings may include various examination apparatus to examine biological samples. The examination apparatus may include a sample reader that senses one or more aspects of the samples. The sample reader also may define the positions of samples before, during, and/or after the one or more aspects are sensed. The examination apparatus also may include one or more local and/or remote controllers for control of, and/or interaction with, the sample reader and/or one or more users, to control, configure, and/or report automated examination of the samples. Further aspects of these examination apparatus are included in the following sub-sections, including, among others, (A) sample readers, and (B) controllers.

A. Sample Readers

The examination apparatus may include a sample reader. The sample reader may be any apparatus configured to detect (measure) a property of biological samples. In some embodiments, the sample reader may have a low profile, so that its average or maximum height is less than or about, for example, twelve, ten inches, or eight inches, among others. The sample reader may include a frame coupled to (i) a detection mechanism, (ii) at least one sample support, and/or (iii) a drive mechanism.

i. Detection Mechanisms

The sample reader may include one or more detection mechanisms, also termed measurement mechanisms. A detection mechanism, as used herein, is any device or set of devices configured to sense one or aspects of a sample. The sensed aspect may relate to the sample's interaction with, and/or production/content of, waves, particles, and/or energy such as radiant, heat, electrical, chemical, kinetic, and/or nuclear energy, among others. Exemplary sensed aspects may include light (e.g., ultraviolet, visible, and/or infrared light) and radioactive emissions (e.g., alpha, beta, and/or gamma emissions). The detection mechanism may be configured to scan samples enclosed in sample holders (such as containers) and/or may operate with sample holders that are open, such as sample holders without lids or covers.

In some examples, the detection mechanism may be a radiation detection mechanism configured to sense a radiative aspect of the sample. A radiative aspect, as used herein, is any property of energy emitted or propagated from a sample, typically in the form of waves or particles, that is produced by and/or changed via interaction with the sample. In some examples, the detection mechanism may be an optical detection mechanism, that is, a mechanism that measures a property of light (that is, ultraviolet, visible, and/or infrared light). Suitable radiative and/or optical properties measured by the detection mechanism may include absorption, luminescence (including photoluminescence (such as fluorescence or phosphorescence), chemiluminescence, and/or electrochemiluminescence), magnetic resonance (including nuclear and/or electron spin resonance), scattering (including light scattering, electron scattering, and/or neutron scattering), diffraction, circular dichroism, and/or optical rotation, among others. The detection mechanism may be configured to measure any suitable photoluminescence including fluorescence intensity (FLINT), fluorescence polarization (FP), fluorescence resonance energy transfer (FRET), fluorescence lifetime (FLT), total internal reflection fluorescence (TIRF), fluorescence correlation (FCS), fluorescence recovery after photobleaching (FRAP), and their phosphorescence and other analogs, among others.

The detection mechanism may be configured as an imaging mechanism that senses images from samples. For example, the detection mechanism may be configured to include a microscope and a camera. A microscope, as used herein, is any optical device that magnifies the image of small objects, such as cells, organelles, tissues, small organisms, particles, etc. Exemplary modes of microscopy that may be performed by the detection mechanism include optical microscopy (for example, brightfield, darkfield, phase-contrast, differential interference contrast (such as Nomarski, DIC, Hoffman Modulation Contrast), fluorescence, and/or or confocal microscopy, among others), electron microscopy, and/or the like. A camera, as used herein, is any device for sensing an image. The camera may be digital and/or analog. Exemplary cameras include CCD cameras and/or film cameras, among others.

The detection mechanism may include a light source and/or a sensor mechanism (also termed a sensor assembly). The light source may include a light outlet from which light exits the light source and is directed to a sample. The sensor mechanism may include a light inlet at which light is received by the sensor mechanism from the sample. Exemplary outlets and inlets may be defined by optical devices (such as lenses, filters, mirrors, etc.), lamp surfaces, and/or sensor surfaces. The light outlet and inlet (and/or the light source and sensor mechanism) may be disposed in a fixed and/or adjustable relation to one another. In some examples, the light outlet and inlet (and/or the light source and sensor mechanism) may be disposed on opposing sides of a plane defined by the sample support to provide trans-illumination of samples, such as for absorbance measurements, standard (e.g., transmission, phase, etc.) imaging, and so on. For example, the light source may be disposed above the sample support and the sensor mechanism below this support, or vice versa. Alternatively, or in addition, the light outlet and inlet (and/or the light source and the sensor mechanism) may be disposed on the same side of a plane defined by the sample support, for example, to provide epi-illumination of samples, such as for fluorescence measurements, fluorescence imaging, and so on.

The light source may include any device and/or assembly that can send light to or illuminate a sample. Exemplary light sources may include one or more lamps and associated optics. Exemplary lamps may include incandescent (e.g., halogen or tungsten filament) lamps, arc (e.g., mercury, mercury-xenon, or xenon) lamps, light emitting diodes, and/or lasers, among others. Associated optics (“source optics”) may include an optical fiber and/or liquid light guide, one more lenses, a filter(s) (such as a polarization or wavelength-based filter), a diffraction grating, a mirror(s), a mask(s), and/or the like. The associated optics may select/adjust the intensity, wavelength, polarization, phase, direction, and/or shape, among others, of light directed to the sample. The light source also may include an outlet from which light leaves the light source, as described above. The outlet may move relative to samples to illuminate different samples and/or sample regions. Alternatively, or in addition, the light source may include a plurality of outlets (contiguous or spaced) to permit a plurality of samples/sample regions to be illuminated at the same time or at different times.

The sensor mechanism may be any device or assembly configured to sense waves/particles and/or energy, such as radiant energy in the form of electromagnetic radiation, particularly an optical sensor mechanism configured to sense light. The optical sensor mechanism may sense light from the light source and/or the sample, among others. The optical sensor mechanism may include receiver optics and/or one or more sensors.

The receiver optics may be configured to direct, modify, shape, and/or select light from the light source and/or sample. Exemplary receiver optics may include any of the source optics described above. Alternatively, or in addition, the receiver optics may include at least one objective (generally, an objective lens) to provide any suitable magnification, such as about 2× to 100×, or about 2× to 40×, or about 2× to 10×. In some embodiments, the receiver optics may include one or more lenses to shrink an image, for example, so that the magnification provided by the objective is reduced before light reaches sensors. In some examples, the objective may include a phase-contrast ring (e.g., to produce phase-contrast illumination), a mask (e.g., positioned to block axial light to produce total internal reflection), an aperture (e.g., positioned in an intermediate image plane to block out-of-focus light), and/or any other suitable microscope optical structure.

The sensor(s) may be configured to sense any suitable type of wave/particle and/or energy. In some embodiments, the sensor(s) may be a photosensor(s) configured to sense light and/or other forms of electromagnetic radiation. The photosensor may have any suitable form, including one or more solid-state sensors, such as a photodiode, or a photomultiplier tube, among others. In some examples, the sensor mechanism may include a plurality sensors disposed in an array. For example, the sensor mechanism may be a charge-coupled device (such as a CCD camera) and/or a complementary metal oxide semiconductor (CMOS) array, among others. The array of sensors may be configured to sense any array of substantially contiguous sample regions or pixels, such as an area within a culture flask or a microplate well. Alternatively, or in addition, the array of sensors may be configured to sense spaced samples and/or sample regions, such as a plurality of wells (e.g., a row, a column, and/or all the wells) of a microplate. Accordingly, the array of sensors may include two or more sets of sensor arrays to collect two or more images at the same or different times (and/or two or more point sensors). Each sensor may measure and/or output analog and/or digital values.

An optical detection mechanism may define any suitable optical path. The optical path, as used herein, is the path traveled by light from a lamp (or other light source) to sensors of the detection mechanism. The optical path may be linear or bent. In some examples, the optical path may bend a total of at least about or greater than 180, 225, or 270 degrees.

ii. Sample Supports

The sample reader may include one or more sample supports, also termed tray assemblies or trays. A sample support, as used herein, is any structure that holds samples in position in/on a sample reader of the examination system. The sample support thus may provide a plurality of examination sites at which samples are disposed. The sample support may be configured to hold the samples indirectly, by holding vessels/containers (sample holders) carrying the samples, and/or to hold the samples directly. The sample support may hold vessels in position fixedly, or vessels may rest on the sample support.

The sample support may have any suitable structure. For example, the sample support may be generally planar, with an upper surface on which vessels may be placed. The sample support may be configured to be stationary during sample scanning or may move relative to a frame of the sample reader during such scanning. The sample support may be fixed to the frame or may be movable relative to the frame. For example, the sample support may be slidable between a retracted or examination position and an extended or loading position.

The sample support may be of unitary construction or may be an assembly or two or more components. In some examples, the sample support may include a support frame and one or more removable inserts configured to be received by the support frame. In some examples, the support frame may be configured to receive at least two or more inserts. The inserts may be selected from a set of different inserts configured for different sample holder/vessel configurations. For example, each insert may be configured to receive one or more of a particular type of sample holder, such as a microplate, a flask, a Petri dish, a biochip, a microscope slide, etc., (particularly various types/brands of commercially available culture vessels and microplates) and/or may be configured to receive a combination of these or other sample holders. The sample support and/or the inserts may include machine-readable indicia (such as a barcode, alphanumeric characters, symbols, a magnetic strip, a chip, a distinctive opening or set of openings, etc.) for automatic identification of the sample support and/or insert(s) thereof. Such indicia may allow the examination system to know what cell culture vessels or other sample holders are loaded onto the sample support when these holders are detected by the detection mechanism (such as during auto-focusing).

The sample support may include one or more light-transmissive windows that permit light to pass through the sample support. The light-transmissive windows may be openings in the sample support and/or may be formed of a substantially transparent material. In some examples, the light-transmissive windows may correspond generally in shape and/or size to the vessels that the sample support is configured to receive.

The sample support also may include one or more retainers that restrict lateral and/or upward movement of vessels/sample holders. Exemplary retainers may include flanges, clips, pins, recesses, and/or the like. The retainers may be formed integrally with the sample support and/or inserts thereof. Alternatively, the retainers may be separate components that can be coupled to the sample support. In some examples, the sample support may include one or more holes (or projections) configured to receive the retainers. The holes may be positioned according to a particular type(s) or class(es) of vessel to be retained or may a generic array which may be used selectively to accommodate different types/classes of vessels. In some examples, the retainers may a set of removable retainers of different sizes (such as different diameters), to allow suitable retainers to be selected to accommodate variations in vessel structure, such as flasks of similar size from different manufacturers.

iii. Drive Mechanisms

The sample reader may include one or more drive mechanisms to guide and control movement within the sample reader. The drive mechanism may include more or more motors and a mechanical linkage that couples operation of the motor(s) to movement of a load. The load may be the sample support (or a portion thereof, such as an individual insert), the detection mechanism (or a portion thereof), and/or the like.

Any suitable motor(s) may be used in the drive mechanism. Each motor may be an AC or DC motor, or may be air-powered, among others. Exemplary motors may be single or multiphase, universal, servo, induction, synchronous, and/or gear motors. The motor may rotary or linear. In exemplary embodiments, the motor may be a stepper motor.

The drive mechanism may employ any suitable linkage to the load. Exemplary linkages may include a belt(s), a screw(s), a gear(s), a chain(s), a cable(s), a pulley(s), a rod(s), rack and pinion, and/or the like. The linkage also may include a guide structure or track that directs and/or facilitates sliding movement of the load. Accordingly, the guide structure or track may include bearings or other elements that promote sliding.

The drive mechanism may include a plurality of drive mechanisms that drive movement along distinct axes. For example, the sample reader may include a distinct drive mechanism for providing movement along each of two or three orthogonal axes. In some embodiments, the drive mechanism may be capable of moving all or portions of the detection mechanism along each of three-orthogonal axes. For example, the light source (and/or its light outlet) and the sensor mechanism (and/or its light inlet) may be movable together (or independently) in a plane, and the sensor mechanism (and/or its light inlet and/or an objective) may be movable along an axis orthogonal to the plane to focus on each sample. In some embodiments, the light source (and/or its light outlet) also may be movable along this axis, together with, and/or independently of, the sensor mechanism. In some examples, the drive mechanism may provide a gantry for movement of the detection mechanism, such as a microscope gantry for movement of a microscope imaging mechanism, to provide an automated microscope.

B. Controllers

The examination apparatus may include one or more controllers. A controller, as used herein, is any device that operates the sample reader, generally automatically, or any other computing device in communication with a device operating the sample reader. Accordingly, the controller may be a local controller and/or a remote computing device.

A local controller may include, for example, an embedded digital computing device with a processor that can perform arithmetic and/or logical operations on data. The local controller also may include memory to store instructions for operation of the sample reader and/or to store data received from the sample reader (or its local controller), particularly sample data from the detection mechanism. The controller also may include a bus to route data within the controller.

A local controller may have any suitable connection to the sample reader. Exemplary connections may include wires, optical conduits, and/or wireless connections. Wireless connections may include communication by electromagnetic radiation through air, such as using visible, infrared, microwave, and/or radiofrequency wavelengths. The connection may provide power to the sample reader and/or may input/output signals to/from the sample reader. The local controller may be adjacent or spaced from the sample reader.

In some examples, the local controller may include a network-connectable local computing device. The local computing device may be configured to provide a local or a remote user with a graphical interface. The local computing device may be configured to be connected to an internal network (a local area network (LAN)), to an external network (a wide area network (WAN) such as the Internet), and/or to a private wide area network, among others). Thus, in some examples, the local computing device may be “internet-aware.” Such networking environments may be found in offices, enterprise-wide computer networks, Intranets, and the Internet. If used in a LAN networking environment, the local controller may be connected to the local network through a network interface or adapter. If used in a WAN networking environment, the local controller may include a modem (such as an ISDN modem, cable modem, DSL modem, telephone line modem, or fiber optic modem, among others) or other means for establishing communications over the wide area network, such as the Internet. The modem may be internal or external. Furthermore, the modem may be connected to the controller via any suitable interface, such as a serial port interface. These network connections are exemplary; generally, any suitable means of establishing communications links between computing devices may be used.

In some examples, the local controller can be accessed from any external computing devices with access privileges. These remote-computing devices may include personal computers, servers, routers, network PCs, peer devices, and/or other common network nodes. These remote-computing devices may run a graphical user interface (GUI), generally a program installed on the remote-computing device, which provides a remote user interface to the local controller. The remote-computing device and the internet-aware local controller may function in a Client/Server relationship in which the remote computing device (the Client) is used to input and/or output data to/from the local controller (the Server). Communication with the local controller may be restricted to authorized users, for example, with a password or other verification process. Several levels of access for authorized users also may be established, including users with full administrative privileges over the local controller as well as users with limited guest privileges. The Client/Server model allows a single local controller to maintain many simultaneous communication links to remote-computing devices, permitting any number of authorized users to retrieve/send information from/to the local controller in parallel. Conversely, the GUI on the Client remote-computing device can establish an arbitrary number of communication links with more than one local controller, permitting a remote-computing device to interact with any number of measurement devices.

Each remote-computing device (and the local controller) may have a unique domain name or Internet protocol (IP) address marking its location on the LAN and/or WAN. To establish a link to a local controller over a communications network, any remote computing device with network access and the GUI program may contact the local controller through a communications network using a network or IP address. When a link request is submitted through a GUI on the Client machine, the Server (the local controller) responds with a request for user authentication. Once authenticated, the Client can interact with the local controller through the GUI according to the access level established for the user. Each time the GUI sends/receives a request for information to/from the local controller, a message is sent between the Client and Server devices. The various requests that are made by the client through the GUI are handled on the local controller Server by web pages, which typically are encoded using the HyperText Markup Language (HTML). Messages that travel back and forth between the Client and the Server generally are transmitted using the HyperText Transfer Protocol (HTTP) and structured using Extensible Markup Language (XML). The contents of the messages may be encrypted when security is required, as in the case of user-authentication passwords.

Exemplary graphical interfaces may include or permit (1) graphical user entry of the arrangement of vessels; (2) examination of the configuration of the examination system, as well as the arrangement of flasks, dishes, or plates that are located within the sample reader, currently or historically; (3) graphical user entry of regions for examination per vessel; (4) scheduling of periodic image collection, such as automated and around-the-clock data collection; (5) an image-based auto-focusing algorithm; (6) image retrieval/archiving/database features; (7) image algorithms for estimating cell confluence and cell counts; (8) attachment of user notes to images; (9) image viewing and enhancement features, such as contrast and brightness controls, image sharpening, and time-lapse movies; (10) software flags that allow users to predict and select optimum times for assay execution based on parameters such as growth rate or confluence; (11) software tools for graphical representation of growth characteristics; (12) generation of time history plots of defined metrics (e.g., cell count, cell size, confluency, fluorescent value, etc.) relative to the acquired data; (13) establishment of administrative and security functions for the local controller; (14) remote examination of cell cultures without the need to physically access an incubator in which the samples are located; (15) facilitated sharing and archiving of sample data between users by providing a standardized means for data collection, sharing and archiving at the local controller; and/or the like.

III. Biological Samples

The examination systems of the present teachings may be configured to collect data from any suitable biological samples. A biological sample, as used herein, may include any particle(s), substance(s), extract(s), mixture, and/or assembly derived from or corresponding to one or more organisms, cells, and/or viruses. The biological sample also may include additional components to facilitate analysis, such as fluid (e.g., water), buffer, culture nutrients, salt, other reagents, dyes, etc. Accordingly, in some examples, the biological sample may include one or more cells disposed in a culture medium and/or another suitable fluid medium.

Particles may include living or dead (such as fixed) cells. Suitable cells may include cells derived from animals, plants, bacteria, and/or fungi (including yeast), among others. The cells may be primary, immortalized, senescent, stem, differentiated, transformed, infected, transgenic, assembled into tissues or multi-cellular organisms (such as embryos), and/or the like. In some examples, the cells may be at least about 0.5 μm in diameter. In some examples, the cells may be adherent cells that are cultured preferentially or exclusively attached to, and/or in contact with, a substrate, such as glass or plastic.

Substances may be include any small or large compounds isolated from (or secreted by) cells. Exemplary substances may include proteins (e.g., enzymes, receptors, binding partners, etc.), peptides, nucleic acids (such as cyclic or noncyclic mononucleotides, DNA, and/or RNA), carbohydrates, lipids, ions, hormones, metabolites, conjugates thereof, and/or the like.

Extracts and/or assemblies may include fractions or organelles isolated from cells. Exemplary fractions and/or organelles may include nuclei, membranes, mitochondria, cytosol, whole cell lysates, etc. Fractions may be crude or partially purified.

IV. Assays

The examination systems of the present teachings may used to perform any suitable assays and/or measure any suitable conditions on biological samples.

The assays may provide qualitative and/or quantitative data about the samples. The data may include the presence and/or activity of a species of interest, and/or the effect(s) of another species (such as a modulator (e.g., agonist or antagonist, promoter or inhibitor, etc.) on the species of interest. The data may be determined directly and/or indirectly (e.g., through the use of one or more reporter species). The assays may involve detection of single or multiple values for each sample, at a single timepoint or during a time course, to provide time-independent (e.g., steady-state or endpoint) or time-dependent values. The data may be averaged or (temporally and/or spatially) distributed values, among others.

Exemplary assays may involve living cells and may collect data from the cells at two or more time points, so that the cells are monitored. Suitable assays with cells may measure appearance (collecting images without any further automatic analysis), growth, density, cell size, cell shape, cell division, distribution (such as clustering), migration (such as due to chemotaxis or metastasis), cell death (such as necrotic and/or apoptotic cell death), differentiation, signal transduction, trafficking, reporter gene activity, gene expression, subcellular features (such as subcellular morphology, location, and/or number, among others), secretion, transformation, transfection, and/or the like. Further examples of assays that may be performed with the assay systems of the present teachings are described below in Section V.

The conditions may provide qualitative and/or quantitative information about the sample and/or system. Suitable measurable conditions may include pH (i.e., hydrogen ion concentration); the concentration or composition of sample constituents such as ions, metabolites, catabolites, and the like; temperature; pressure; the composition of the atmosphere (e.g., CO₂ concentration); etc. Such conditions may relate to and/or comprise cell culture conditions, among others.

### V. EXAMPLE

The following examples describe selected aspects and embodiments of the present teachings, including an exemplary sample reader, exemplary graphical interface configurations, and exemplary assays, among others. These examples and the various features and aspects thereof are included for illustration and are not intended to define or limit the entire scope of the present teachings.

### Example 1.

Reader Module

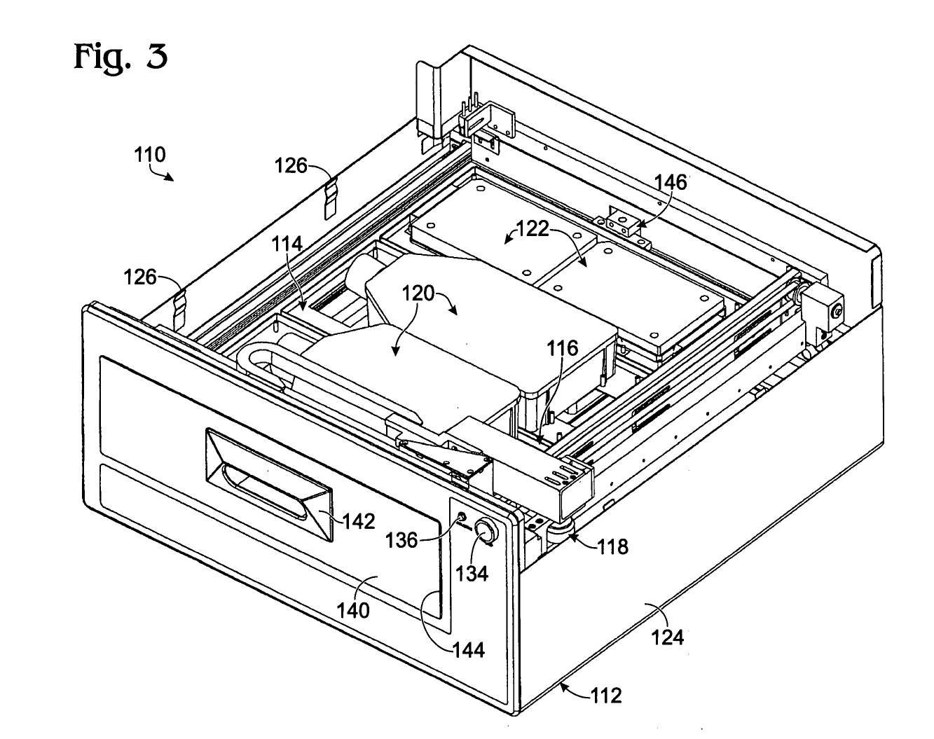

This example describes an exemplary sample reader module configured to be received in a tissue culture incubator; see FIGS. 3-9. The reader module may be included in any suitable systems for examination of biological samples.

The reader module described in this example may be used to provide microscopic examination of a plurality of plates, flasks, dishes, or microplates, among others, inside a controlled and characterized environment of a standard (commercially available) CO₂ cell culture incubator. The reader module may be configured to include a microscope included in a microscope gantry that automatically scans cells in containers supported by the reader module. Because the samples remain in an incubator, kinetic images over time can be collected without the need to limit the assay time due to environmental constraints (such as unacceptable changes in temperature and/or pH of the samples). In addition, the microscope is fitted to a computer-controlled 3-D gantry system that includes autofocusing capability. Accordingly, images can be collected around the clock, without human intervention and without the expense of a fully-automated robotic system. This configuration may enable studies that are impossible to perform during the course of an eight hour work day and provides the added advantage of not having to remove biological samples from the incubator during observation. The size of the module is relatively small, particularly its vertical profile (˜8 inches in height), so as to utilize less than half of the internal volume of most commercially available CO₂ incubators. This small size maintains the functionality of the incubator for placement of other biological samples outside of the module. This small size also helps to minimize air flow restrictions that can have detrimental effects, such as condensation and improper sample aeration on the module or the biological samples.

The reader module may be included in an examination system having a separate local controller with an embedded computer to carry out control functions of the reader module. In use, the reader module may be placed into various commercially available CO₂ incubators, for example, on a single shelf of an incubator, and the local controller may be left outside the incubator. Low voltage electrical cables may connect the two parts. This configuration may help to reduce the size of the reader module for placement in the incubator. Furthermore, with this configuration, most sensitive electrical components may remain outside of the high humidity environment of the incubator. Electronic printed circuit boards in the reader module (such as a part of a CCD camera) may receive a commercially available conformal coating to increase their resistance to the effects of humidity.

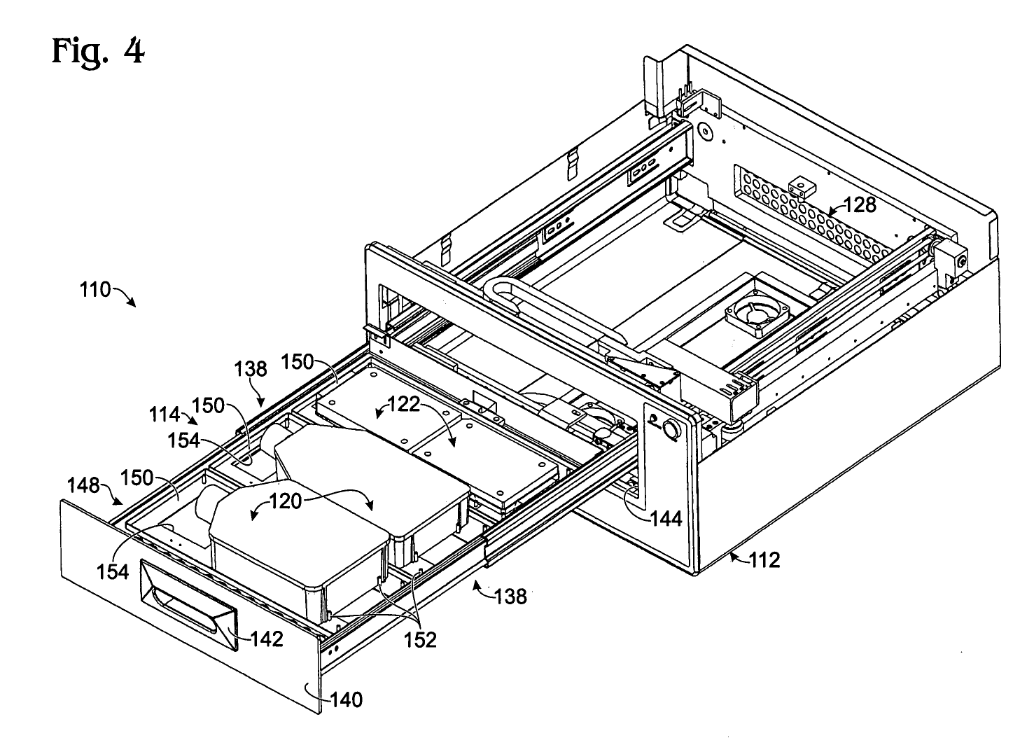

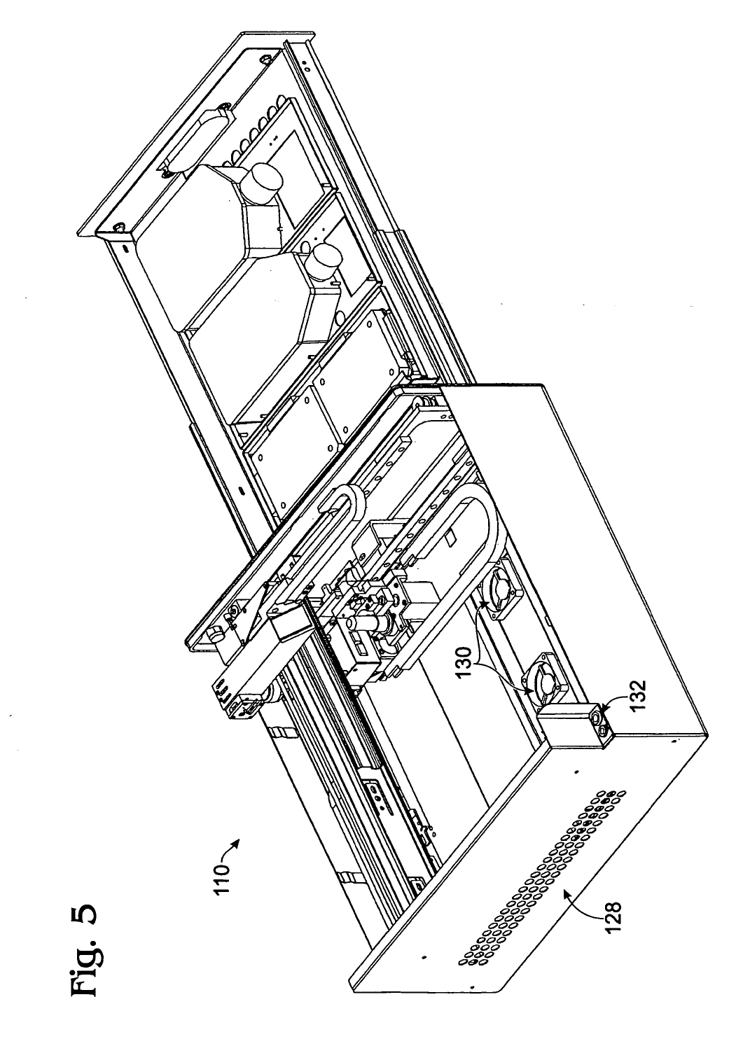

FIGS. 3-5 show various views of the reader module 110. FIGS. 3 and 4 are taken generally from above and in front of module 110, and FIG. 5 is taken generally from above and behind the module. FIG. 3 shows an examination configuration in which sample data may be read, and FIGS. 4 and 5 show a loading configuration in which samples may be added to and/or removed from the module.

The reader module 110 may include a housing 112 and a sample support tray 114 received in the housing. In addition, the reader module 110 may include a microscope-based imaging mechanism 116 coupled to a 3-D gantry system or drive mechanism 118. The imaging mechanism 116 may provide a two-dimensional image with a two-dimensional sensor array, such as a CCD camera, or a single point detector may be spatially scanned over a sample to form a 2-dimensional image. The gantry system 118 may move the imaging mechanism laterally in the X-Y dimensions over the tray 114 holding sample containers (e.g., T-flasks 120 and microplates 122), so that images may be collected of samples in distinct containers and/or of distinct sample regions with the same container. The 3-D gantry system may allow the imaging mechanism to be focused in the vertical Z dimension automatically. This autofocusing capability may allow the examination system to be capable of acquiring a sequence of images of different biological samples (or sample regions) without human intervention.

The housing 112 may include a cover that may be removably received on a base section 124 of the housing, for example, by mating with clips 126. The housing and/or the cover may include openings, such as perforations 128 (see FIGS. 4 and 5), to facilitate equilibration with a surrounding incubator chamber. The housing also may include one or more fans 130 (see FIG. 5) to facilitate this equilibration. Moreover, the housing may include one or more electrical connectors 132 (see FIG. 5), to provide, for example, connection to the local controller and/or a power outlet, among others. Furthermore, the housing may include or hold one or more switches and/or indicators, such as on/off switch 134 and indicator light 136 (see FIG. 3).

Tray 114 may be slidably received in housing 112, to move between loading and examination configurations of the tray (compare FIG. 3 with FIGS. 4 and 5). For example, tray may slide in and out of the housing by riding along telescoping guide mechanisms 138 (see FIG. 4) that direct and facilitate sliding movement. The reader module also may include springs to assist initial sliding moving of the tray out of the housing, for example, to reduce sudden movement of the tray that may agitate fluid and/or samples. The tray may be configured to be moved automatically and/or may be pulled out manually. For example, the tray may be attached to a door or faceplate 140 having a handle 142. The housing may include an opening 144 sized to receive the door. Moreover, the housing may include a latch or catch, such as magnetic catch 146 (see FIG. 3) to hold the tray 114 in the retracted, examination configuration. Furthermore, the reader module may include a sensor that senses when the tray is in its extended and/or retracted positions.

Tray 114 may be configured to hold a plurality of tissue culture containers, such as T-flasks 120 and microplates 122 from various vendors. The tray may include a tray frame 148 and a plurality of inserts 150 (in this case, three) received by the tray frame (see FIG. 4). Each insert may include retainers, such as pins 152, to engage the tissue culture containers and restrict their lateral movement. In some examples, the pins may hold removable adapters of a suitable diameter. Each adapter may be selected (from a set of supplied adapters of different diameter) according to the perimeter of the container to be retained, to provide a more customized engagement of the retainers with the containers. Furthermore, the pins may be employed selectively according to the particular configuration of containers to be loaded onto each insert. The inserts also may include windows such as openings 154 through which cells in the containers may be imaged. Accordingly, the windows may be disposed suitably relative to pins 152, so that the windows and the containers are aligned and/or overlap.

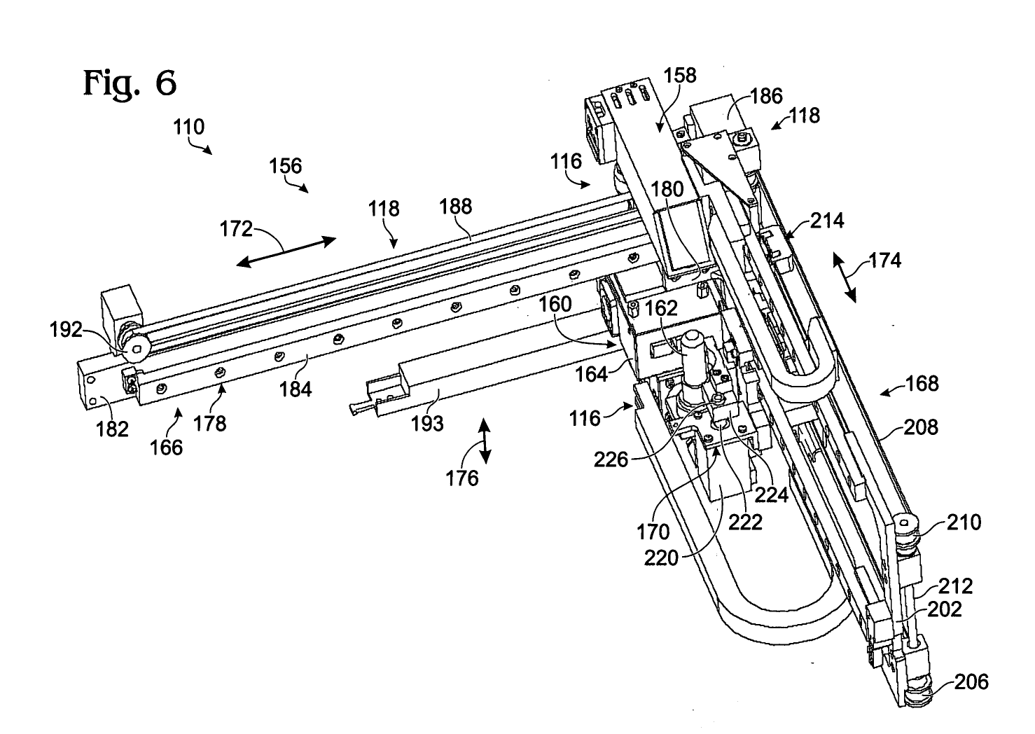

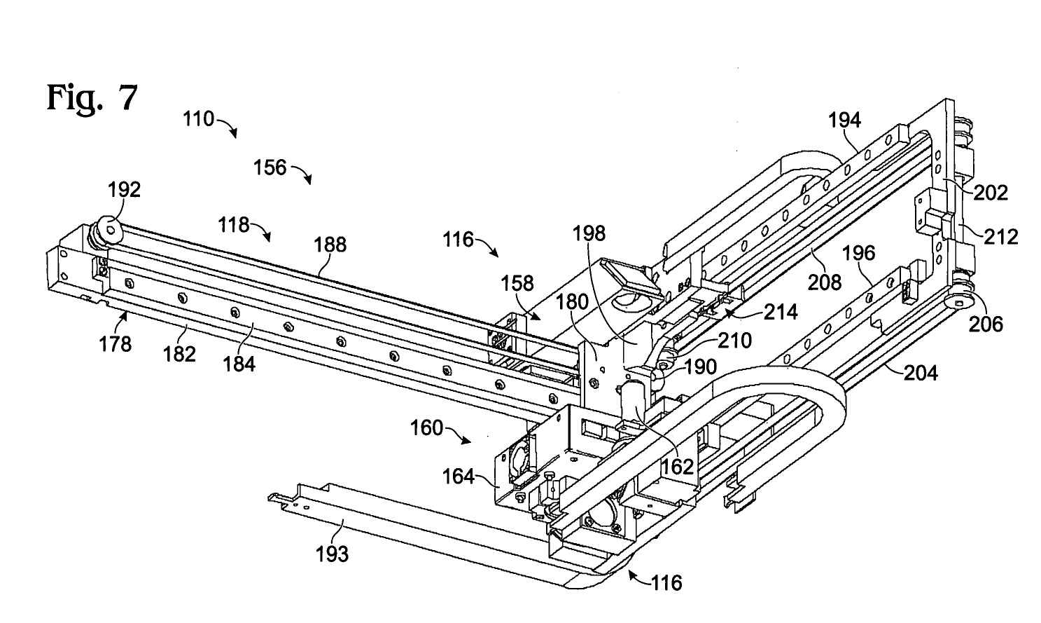

FIGS. 6 and 7 shows views from above and below, respectively, a microscope gantry 156 of the reader module 110. The microscope gantry includes imaging mechanism 116 and gantry system 118.

Imaging mechanism 116, which may function as a microscope to image samples, includes a light source 158 and a sensor assembly 160. The light source and the image sensor mechanism may be disposed above and below the sample tray 114 (see FIGS. 3 and 4). The sensor assembly may include an objective 162 and a camera 164, such as a digital camera, among others. Further aspects of the light source and sensor assembly are described below in relation to FIG. 9.

The gantry system 118 may provide automated positioning of the image sensor mechanism (or components thereof) along three orthogonal axes (X, Y, and Z) to permit sample scanning within an X-Y plane and autofocusing along the Z-axis. Accordingly, the gantry system may include a plurality of drive mechanisms, a Y-drive mechanism 166, an X-drive mechanism 168, and a Z-drive mechanism 170, configured for driving movement along the Y-, X-, and Z-axes, respectively, shown at 172, 174, and 176 (see FIG. 6).

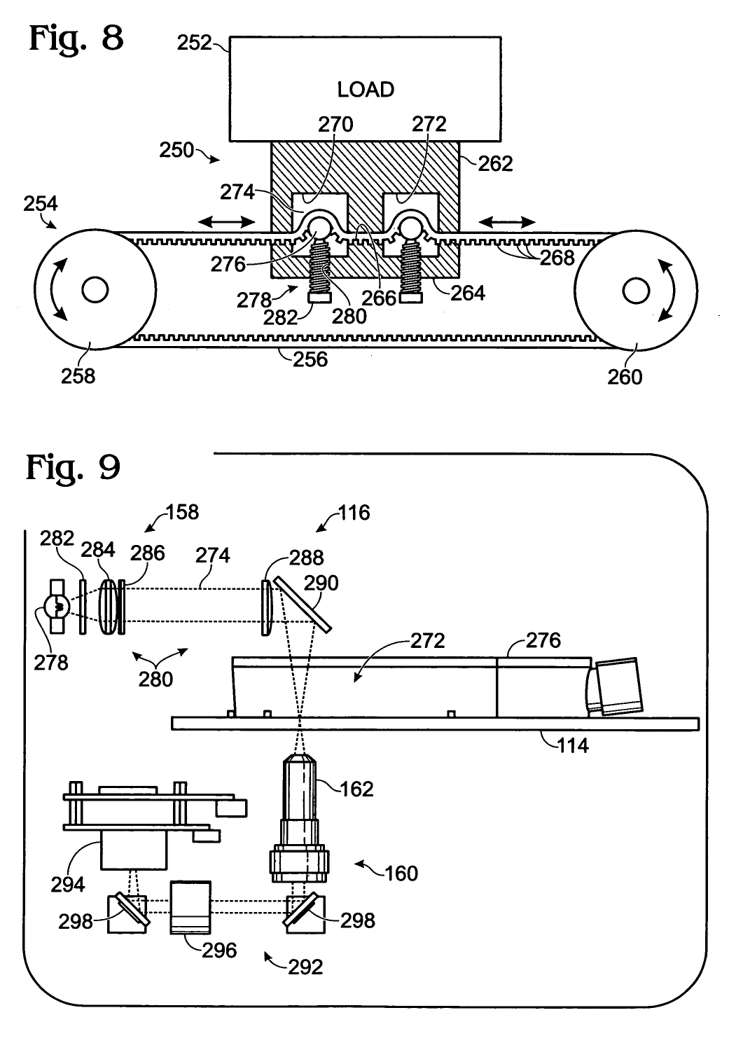

The Y-drive mechanism 166 moves the imaging mechanism (or components thereof) along the Y-axis. The Y-drive mechanism may include a Y-axis rail 178, along which a carriage 180 may slide. The rail may include a support beam 182 and a translational bearing set 184. The Y-drive mechanism also may include a Y-axis stepper motor 186 coupled to a driven belt 188 via a main pulley 190 (see FIG. 7). An assist pulley 192 may hold an opposing end of the belt. The Y-axis stepper motor 186 and Y-axis rail 178 may be earthed mechanically, that is, secured to a fixed portion of the frame or housing of the reader module 110. In contrast, the carriage 180, which is coupled to the imaging mechanism 116, may be secured to the belt 188, so that operation of the Y-axis stepper motor provides movement of the carriage and the imaging mechanism along the Y-axis. A cable carrier 193 (and one or more additional cable carriers) may hold electrical conduits that facilitate this or movement along other axes. Further aspects of a cleat mechanism for securing the carriage to the belt are described below in relation to FIG. 8.

The X-drive mechanism 168 moves the imaging mechanism (or components thereof) along the X-axis. The X-drive mechanism may include an upper rail 194 and a lower rail 196 with translational bearing sets similar to Y-axis rail 178 (see FIG. 7). The upper and lower rails may be secured at their proximal ends to carriage 180 via angle member 198. The upper and lower rails may be held at a fixed spacing by a spacer member or rail spreader 202 secured to these rails at their distal ends to form a parallelogram. This parallelogram translates along the Y-axis of the module with operation of the Y-axis stepper motor 186.

The X-drive mechanism also may include an X-axis stepper motor coupled to a driven belt 204 via a driven pulley (see FIG. 7). An assist pulley 206 may be coupled to the rail spreader 202 to hold an opposing end of the belt. The sensor assembly 160 may be secured to the driven belt 204 with a cleat assembly, so that the sensor assembly is driven along the lower rail 196. The X-drive mechanism also may include a slaved belt 208 disposed in parallel to driven belt 204. The slaved belt may be driven indirectly by the X-axis stepper motor via a slaved pulley 210 that is attached to the driven assist pulley 206 via a slaving shaft 212 (see FIG. 6). Accordingly, the slaved belt 208 is induced to move at the same time and speed as the driven belt 204. The light source 158 may be secured to the slaved belt 208 with a cleat assembly 214, so that the light source slides along the upper rail 194 at the same time and speed as the sensor assembly 160. Accordingly, motion of driven belt 204 is transferred by transitivity to slaved belt and thus the light source. Further aspects of a cleat assembly for securing and positioning the light source and sensor assembly to their respective belts are described below in relation to FIG. 8.

The Z-drive mechanism 170 (see FIG. 6) may be used to focus on samples disposed on the sample tray. The Z-drive mechanism may include a Z-drive motor 220 that drives rotation of a Z-drive screw 222 affixed to the shaft of this motor. The Z-drive mechanism also may include a Z-carriage 224 attached to objective 162. The Z-carriage may include a translational bearing set and a nut 226. The nut may be threadably coupled to the Z-drive screw so that rotation of the screw by the motor raises or lowers the Z-carriage and the objective translationally, according to the direction of motor rotation, thus adjusting the focus. Focusing may be performed automatically, without user intervention, as described below in Example 2.

FIG. 8 is a somewhat schematic view of a coupling mechanism or cleat assembly 250 securing a load 252 to a portion of a drive mechanism 254. The drive mechanism may include a belt 256 and one or more pulleys, such as a drive pulley 258 and an idler pulley 260. Due to a combination of manufacturing and assembly tolerances, and belt stretching, the use of fixed pulley center distances may not be suitable for some drive mechanisms, such as the belt-drive mechanisms of the present teachings. A novel method and device for adjusting belt tension and longitudinal position of a load to be translated is presented here.

The cleat assembly 250 may include first and second cleat members 262, 264 that can be secured together around the belt with one or more suitable fasteners, such as screws, bolts, and/or nuts, among others. The second cleat member 264 may include one or more protrusions 266 received between teeth 268 of the belt, to restrict longitudinal slippage of the belt. The cleat members may define one or more pockets 270, 272 when the cleat members are clamped together around the belt. Each pocket may include side walls 274 that restrict lateral movement of the belt. Furthermore, each pocket may hold a tension element 276 configured to bear on a portion of the belt, on one side of the belt.

The position of each tension element may be adjusted by a corresponding adjustment mechanism 278. The adjustment mechanism may include a threaded opening 280 formed by the second cleat member adjoining each pocket. Each threaded opening may be threadably engaged with an adjustment member, such as a set screw 282. Turning each set screw 282, in one of two opposing rotational directions, moves the tension element generally orthogonal to the longitudinal direction of the belt. This movement of the tension element against the belt lengthens or shortens the path followed by the belt, according to whether corresponding movement of the tension element produces greater or lesser deformation, respectively, of the tension belt. Greater deformation generally increases the belt tension and lesser deformation generally decreases the belt tension. This adjustment technique may provide continuous adjustment capability (as opposed to discrete adjustment steps) and generally does not require repositioning and subsequent reclamping of mechanical elements of the cleat assembly.

The belt and the tension elements may have any suitable structure. For example, the belt may be an open-ended length of belting or a closed-loop belt. If an open-ended length of belt is being employed, the tag ends of the belt may be laid into a grooved portion of the cleat assembly with a proscribed gap between them. Each tension element may have any suitable shape, including cylindrical, spherical, frustoconical, or cuboidal, among others.

The existence of two tension members that are independently adjustable allows not only adjustment of belt tension, but also provides a means for continuous adjustment of the longitudinal position of the driven load relative to the rotational orientation of the drive pulley 258. In particular, selective adjustment of each set screw may move the load closer to the drive pulley 258 or the idler pulley 260. The advantage of this longitudinal adjustment capability may be substantial in devices employing multiple sets of timing belts, one or more of which is slaved to another. The phasing of a slaved belt mechanism can be precisely adjusted relative to a master belt mechanism by selectively turning set screws 282.

Cleat assembly 250 may be used in the reader module 110 to secure portions or all of the imaging mechanism 116 adjustably to the gantry system, particularly the X- and Y-drive mechanisms thereof. In particular, the imaging mechanism may be secured to the Y-drive mechanism, and the light source 158 and sensor assembly 160 may be secured to master and slaved belts (204 and 208) of the X-drive mechanism (see FIGS. 6 and 7).

FIG. 9 shows selected portions of the imaging mechanism 116 (see FIGS. 6 and 7) positioned to image a sample 272. The imaging mechanism is shown directing light along an optical path 274 from the light source 158 to the sensor assembly 160. The sample is contained in a culture vessel 276 resting on the tray 114. The imaging mechanism in the present illustration includes a phase contrast microscope with transmitted illumination.

The light source 158 may include a lamp 278 and associated source optics 280. In exemplary embodiments, the lamp may be a halogen bulb (such as a 5 W bulb) and/or a high efficiency solid state (LED) source. Light emitted by the lamp may pass through a weak diffuser 282 and then may be coarsely collimated by collimating lens 284, such as an aspheric lens of short focal length. The collimated light then may strike an annular mask 286. The annulus of light exiting the mask then may be focused onto the sample 272 using a longer focal length condenser lens 288. The focal length of the condenser lens may be chosen to provide a suitable working distance to the specimen, for example about 80 mm. The dimensions of the annulus may be chosen such that the cone of light exiting the condenser lens 288 is imaged onto a phase ring in the microscope objective. To minimize the height of the light source, a turn mirror 290 may be placed after the condenser lens 288 in the optical path.

The sensor assembly 160 may include receiver optics 292 and a camera 294. The receiver optics may include an objective 162. The objective may provide any suitable magnification, such as about 20× magnification. In some examples, the objective may have an infinity-corrected design with an integral phase ring. To make a more compact optical assembly, the objective may be paired with a tube lens 296 of 60 mm focal length rather than a more standard 200 mm focal length. This results in a true system magnification of 6×. Two turn mirrors 298 (also termed fold mirrors) may be used in the microscope optical path to further compact the assembly. The image then may be focused onto a CCD array of the camera. In exemplary embodiments, each element of the CCD array may be a six μm square pixel, resulting in a one μm image resolution. In some examples, the image resolution may be about 0.1-5 μm or about 0.5-2 μm to fully resolve the morphology and fine structure of typical cultured cells.

The imaging mechanism may be geared towards using the examination system as a tool for general examination of cells, typically done with phase contrast microscopy and thereby not requiring stains or labels. Other embodiments may make use of other microscope configurations, e.g., epi-fluorescence or differential interference contrast, each which has its particular advantages depending on the application. Epi-fluorescence for example, may utilize a filtered white light or laser source which illuminates the sample using the imaging objective, typically from below the sample. For adherent cell layers, imaging from below may be advantageous to avoid background fluorescence associated with extracellular fluid. An epi-fluorescent scheme in the context of the present teachings may be advantageous for assays such as protein trafficking where one may want to track the formation and/or migration of fluorescently “tagged” protein molecules in living cells for hours or days (see Example 10).

### Example 2.

Autofocusing Features of Examination Systems

This example describes exemplary autofocusing features that may be included in examination systems, particularly for autofocusing along the Z-axis.

To keep the package size small, and the cost of the hardware at a minimum, the systems may use passive autofocusing to re-focus a microscope as it moves to different spatial locations in the sample reader. Passive auto-focusing may be image based, that is, relying on controller-based analysis of images collected by the optical system to find the optimum depth of focus for the microscope. This is in contrast to active focusing, which may rely on a special light source/detection system (e.g., a laser) to provide a means to find the optimum focus depth for the microscope. In some embodiments of the examination system, an image “sharpness metric” may be used. This sharpness metric may rely on the effective contrast achieved by the microscope in finding the bottom of a sample container.

To make the passive autofocusing more efficient, a one-time (or periodic) calibration may be performed on the imaging mechanism. Using a specially configured tray (e.g., a tray containing a pattern or grid such as a reticle), this calibration defines the 3-dimensional plane of the tray with respect to the microscope gantry. These one-time or periodic calibration measurements are used to define the center points of a “coarse” scanning plane for the microscope, which defines the nominal Z depth for a given X-Y spatial location of the tray. This gets the microscope close enough such that a small Z-scan of the objective can be used to find the optimum focus point. The scan depth of the autofocusing scheme is then driven by the effective optical flatness of the specific containers (such as flasks or microplates) loaded into the sample reader. It is desirable to have a small scan depth to minimize the number of images (time) required for autofocusing. In some embodiments, autofocusing takes between 2-6 seconds, depending on the types of containers and types of cells being used in the sample reader.

### Example 3.

Exemplary Interface Configurations

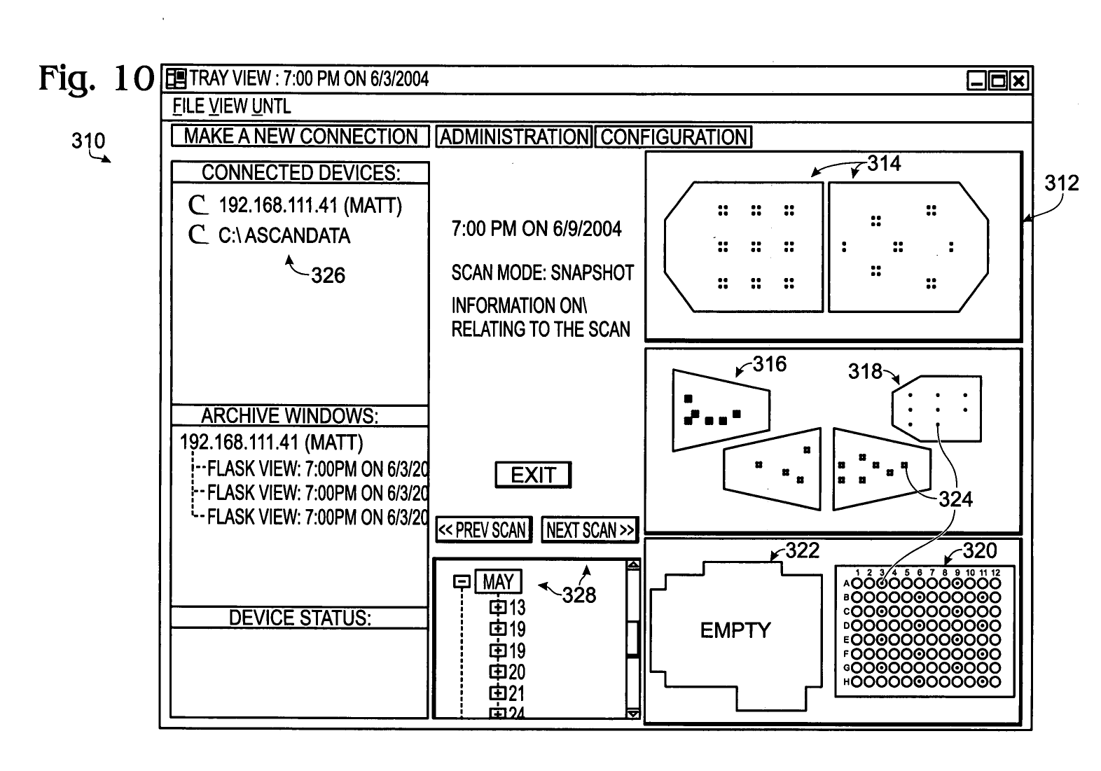

This example describes exemplary graphical interface configurations that may be presented to a user by a remote computing device in network communication with the local controller; see FIGS. 10-12. These graphical interface configurations may be used to perform any suitable tasks including accessing archived data and/or scheduling/configuring tasks to be performed by the local controller and/or the sample reader, among others. Exemplary graphical interface configurations may include windows termed “Tray View,” “Configuration View,” and “Flask View.”

FIG. 10 shows an exemplary screen shot of a Tray View window 310. The Tray View window may provide a pictorial snapshot of the configuration of the sample tray, as if a user were looking down on the sample tray of the sample reader. Accordingly, the Tray View window indicates the current (or a past) loaded configuration of the sample reader at a particular time, that is, the configuration/types of inserts in the tray (in this case three different inserts) and the types/positions of sample holders loaded in each insert, shown at 312. For example, in the present screen shot, a first insert is loaded with two larger flasks, shown at 314, a second insert is loaded with smaller flasks of two different shapes, shown at 316 and 318, and a third insert is loaded with a microplate in one position and is empty in a second position, shown at 320 and 322, respectively. Sensing of the presence as well as type of insert may be performed by imaging identification slots (or other optically detectable indicia) on each insert with the imaging mechanism of the sample reader, and analyzing these images with the local controller. Sensing of whether a position on an insert is loaded with a sample holder or is “empty” may be performed by imaging the position with the imaging mechanism at different autofocus positions of the objective. In particular, image contrast measurements acquired at different focal depths may be compared with contrast threshold values stored in the local controller to distinguish loaded from empty positions.

Imaging positions 324 within each sample holder also may be indicated graphically by the user interface. These positions may be indicated with dots or other suitable visible indicators. Each imaging position may represent a position at which an image has been collected and/or is scheduled to be collected. The imaging positions may be clustered, such as 2-by-2 or 3-by-3 arrays of such positions, among others.

The Tray View window 310 also may have a number of other features. For example, multiple devices may be connected via the user interface at any one time, as shown at 326. Devices may be actual physical devices (i.e., readers), or may represent historical archived data files. Different icons may be used to denote whether a line item refers to a device or to an archive, and different window coloring and/or highlighting may be used to distinguish from which device data is being displayed. Furthermore, the window may permit a user to page backwards or forwards in time, shown at 328. This feature may allow users to set time flags to delimit the beginning and end of defined data sets, for example, according to dates and/or particular scans on these dates, among others. These data sets then may be used to form kinetic time plots of various image metrics (e.g., confluence or cell count).

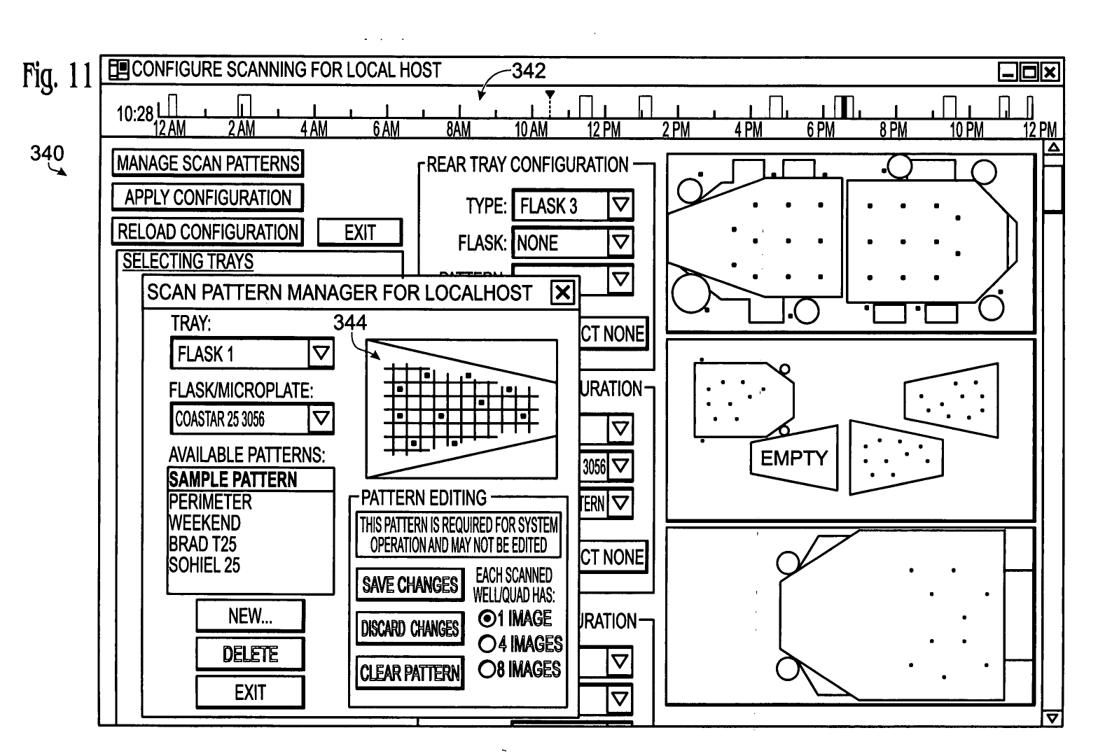

FIG. 11 shows an exemplary screen shot of a Configuration View window 340, which is another graphical interface window. This window may allow the user to set up or “configure” the examination system for data collection. Some of the features of the window may include a horizontal (or vertical) timeline 342 located across the top of the window, which may allow users to define data collection times by dropping tabs along the timeline. The timeline may be set up on a 24 hour clock. This window also may allow the user to inform the controller of the particular type of sample holder (such as a particular size/brand/shape of flask) loaded onto the tray insert. The user may be offered a library of commonly used sample holders to choose from in defining experiments. The tray inserts may be different due to the different sizes and shapes of various commonly used containers for modern day cell culture, but certain tray inserts may be able to handle a variety of flasks, e.g., different varieties of T-75 flasks (with different shapes and thus potential scan areas) may be loaded onto a suitably configured tray insert. Furthermore, this window may allow the user, through the Scan Pattern Manager, to define and save particular scan patterns (that is, the particular positions to be imaged) for each individual sample holder, shown at 344. Each scan pattern may define how many images of each sample are collected from a sample container, as well as where they are collected spatially in the container. Once defined, the scan patterns, as well as the tray configurations can be saved and recalled by the user.

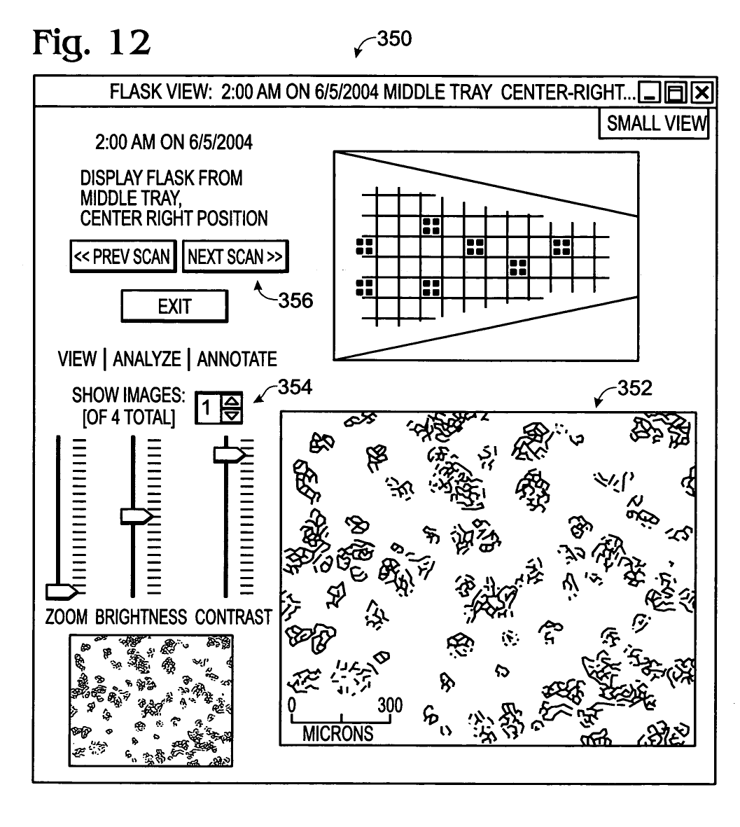

FIG. 12 shows an exemplary screen shot of a Flask View window 350, which is another graphical user interface (GUI) window. This window may be presented to the user upon “double-clicking” or “opening” a container from the Tray View window of FIG. 10. The Flask View window allows the user to look at the specific images, such as image 352 of cells, collected from each defined spatial region across the container. The window also may present several image enhancement features including digital zoom, panning, brightness, and/or contrast displays, shown at 354, for manipulation of the presented image 352. The user also may have the ability to page backwards or forwards in time, shown at 356, while looking at the imagery. This feature also may be used, as in the Tray View window, to set time flags for defining kinetic plots of image metrics (e.g., cell count).

### Example 4.

System Configurations and Potential Advantages

This example describes exemplary configurations of the examination systems of the present teachings and possible advantages of some of these configurations.

In some configurations, the sample reader of an examination system may be disposed in a standard CO₂ incubator for time-lapse examination of cell layers during continuous culture (e.g., over 1-5 days). Due to the length of the incubation time, it may preferable that the sample reader remain in the incubator during cell culture so as not to adversely affect the culture.

In some configurations, the examination system may be used for automatic examination of cell cultures (or other biological samples) outside of an incubator. As an example, most modern high-throughput screening laboratories have automated robotic systems for moving cell samples from incubators, to fluid handling devices, and finally to assay measurement devices (detection mechanisms such as an optical reader). An automatic examination system could be used as a last minute quality control aid before an assay is performed on a cell sample. Cell samples could be pre-screened based on some user-defined quantifiable metric(s) of cell health. In these configurations, the examination system may be one “station” of a larger automated screening system and due to the short time before assessment and assay execution may not require integration into a CO₂ incubator.

The present teachings may improve the practicality and cost effectiveness of sampling the general characteristics of cultured cells including morphology, confluence, growth rates, and/or contamination. In addition, the present teachings may allow for the implementation of user-defined and quantifiable “metrics” based on collected images of samples, particularly digital images of cells. The metrics may in-turn provide a documented, quantitative, and/or objective record of cell attributes. Examples of how the present teachings may aid scientists in cell-based assay development and execution are presented below in numbered paragraphs.

1) Automatic and quantitative examination would allow for cell culture characteristics such as growth rate to be considered in the process of selection cloning (gene expression) of recombinant cell lines. Due to the manual nature of the process, this information is not considered in current clonal selection techniques.

2) By providing an objective, quantifiable, and archived record of cell culture characteristics, assay developers can utilize this information to optimize timing and culture conditions for each assay. This information can be used subsequently as a quality control tool in execution of the assays as well as to help establish standard laboratory practices.

3) An automatic examination system could be used as part of a modern screening system to provide a last-minute quality control check of samples before testing. Due to the quantity of samples currently assayed, modern high-throughput screening laboratories do not have this capability.

4) A quantitative measure of cell culture characteristics can be used to extrapolate optimum assay execution times based on certain features such as optimum confluence or growth rates. This information can be used to “flag” users for optimum assay execution times.

5) By incorporating automatic examination, one can potentially reduce the risk of contamination associated with manual examination and handling of the culture containers. It also helps alleviates transients in temperature and partial gas pressures introduced by repetitive manual access to the incubator.

6) Automatic examination allows for the capability of remote examination, allowing users to perform examination from their desk or home reducing some of the unnecessary and tedious aspects of maintaining cultures.

7) By maintaining a readily-accessible archived digital record in a common format, it is easier to share information between managers, scientist and technicians regarding the on-going assessment of cell health.

### Example 5.

Non-Invasive and Invasive Analysis of Samples

This example compares non-invasive and invasive analysis of samples.

The potential to gather multiple time point images of samples (such as viable and proliferating cells) over extended time periods may allow the development of non-invasive algorithms to quantitatively characterize the samples. A non-invasive algorithm, as used herein, is an algorithm that does not depend on using fluorescent dyes or reagents to “label” the cells for identification. Non-invasive algorithms may rely only on the basic microscopic image of label-free cells to provide quantitative metrics (e.g., cell number, cell size, cell shape, and/or confluency, among others). A non-invasive technique may be desirable for multiple time point measurements of cell proliferation as labeling reagents can alter or even stop normal cellular physiology.

An example of an invasive technique would be the use of the membrane exclusion dye Trypan Blue for counting cells. Trypan Blue permeates the cell membranes of non-viable cells, staining the cells blue. The dye is typically used on cells that have been lifted (in the case of adherent cultures), and re-suspended in simple saline buffer. Re-suspension of the cells in saline solution may be preferred as the dye can bind to proteins found in more complex media formulations, providing a dark and spurious background. The dye staining aids in distinguishing cells from debris as well as in determining the viable cell count. An obvious advantage of a non-invasive cell counting technique (i.e., one not requiring the use of a dye) is the elimination the time and cost of preparing the cells (lifting, resuspension, etc.) as well as the reagent cost. In addition, techniques that require cell staining would typically be used as an end-point measurement (i.e., an aliquot of cells would be stained, counted, and discarded), as exposure to the stain can affect the long-term health of viable cells.

### Example 6.

Cell-Based Assay Optimization

This example describes cell-based assay optimization using the examination systems of the present teachings.

The dividing times for most mammalian cell lines are on the order of 12 to 30 hours. As such, a useful time separation for collecting multiple time point data of proliferating cells is on the order of 4 to 12 hours. In many cases, updates at shorter times may not add any more information, and updates at longer times (e.g., every 24 hours) may not fully elucidate the dynamic characteristics of the proliferation profile. Most modern cell counting systems are invasive, i.e., the cells must be suspended and those counted are labeled, counted, and discarded. Such assays only provide a single time point determination. In addition, because the samples are generally run manually, it is not convenient or practical to make cell counts every 4, 8, or 12 hours.

The examination systems described herein may be capable of collecting imagery at pre-programmed time intervals automatically and without human intervention over extended time periods. Coupled with non-invasive, reagent-free cell counting algorithms, these systems facilitate gathering multi-timepoint cell proliferation profiles. These profiles, in turn, can be used to optimize cell-based assays based on an objective, quantifiable metric which is not dependent on a human interpretation. For example, the systems described herein could be used to determine the optimum confluency or cell density required to maximize the expression of a particular protein or functional response of the cell. Having quantified the cell-based assay in this manner, these systems can then be used to then help predict the optimum time for assay execution of future assays. This could greatly enhance the quality and reproducibility of the output of cell-based assays.

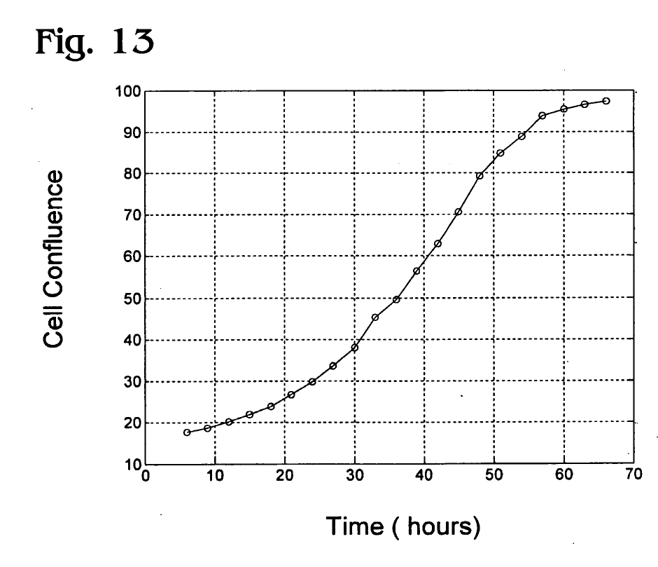

FIG. 13 shows a plot of exemplary confluency data collected over time with an embodiment of an examination system constructed in accordance with aspects of the present teachings. This data exemplifies the type of data that can be extracted based on non-invasive metrics. In this plot, phase contrast imagery was collected by the device from a T-25 flask every 3 hours over a period of 3 days. The digital imagery was then run through an algorithm which computed the relative area of the bottom of the flask covered in cells, in comparison with the area not covered by cells (defined as the relative confluence of the cell mono-layer). Access to this type of data would allow developers to optimize and/or standardize their assay development according to defined time points on the proliferation curve (e.g., denoting the end of logarithmic growth phase), thereby enhancing assay reproducibility. Although not shown, other definable metrics such as cell number, cell size, cell shape, and/or other factors related to general cell morphology may also be applicable.

### Example 7.

Cell Culture Quality Control

This example describes the use of examination systems of the present teachings to implement quality control of cell culture.

One exemplary application for the present teachings is for cell culture quality control. Most cell culture examination is still done by a person removing a sample from the incubator, performing a manual examination using a phase contrast microscope, and then perhaps recording some observations by hand. A typical result might be to record the confluency (area covered by cells vs. area not covered by cells) of the flask as well as any comments on the cell morphology. This process is labor intensive. In addition, the assessment of cell health, morphology, or even the growth stage of the biological sample is subjective and qualitative by nature. Also, a permanent record (e.g., in the form of a recorded image) of the sample is generally not created.

As previously described, the examination systems may be capable of providing a consistent, quantifiable metric to the culture (e.g., cell count or confluency), and since it is non-invasive, capable of providing kinetic time plots of such metrics. These plots may be useful to track changes in growth characteristics of the cultures over time, or in response to unexpected changes due to different cell culture technicians or growth conditions.

The present teachings also allow for a convenient and labor-free means to acquire a permanent record or archive of the data in the form of 2-D or 3-D imagery as part of standard cell culture. Furthermore, as cells are harvested and used in an assay, the archived imagery provides a permanent visual record of the cell culture, which can be used as a quality control measure to enhance assay reproducibility.

### Example 8.

Proliferation Assays

This example describes exemplary proliferation assays that may be performed with the examination systems of the present teachings.

Other applications of the examination systems may include pharmacological profiling and screening assays that are based on cellular proliferation. Most proliferation assays require the use of labeling reagents that tag cellular constituents which are only proportional to viable cell number. Examples include measurements of radio-labeled (e.g., tritiated) thymidine uptake or ATP turnover. Most of these assays require several processing steps, plus a labeling reagent. In addition, the assays are single-time point, invasive determinations.

The systems of the present teachings may allow for a multiple time point determination of cellular proliferation. As an example, many cancer therapies rely on finding compounds that prohibit cellular proliferation, i.e., inhibit the growth of tumor cells. As such, the examination systems may provide kinetic read-outs of cellular proliferation, which may provide insights into the mode of action of pharmacological agents not easily discernible in single timepoint determinations. Lastly, these systems may allow for a direct “label-free” method of monitoring cellular proliferation without the added cost and undesirable effects of using labeled reagents.

### Example 9.

Cytotoxicity Assays

This example describes exemplary uses of examination systems of the present teachings to perform cytotoxicity assays.

Another application of interest may be in the determination of cytotoxicity profiling. It is quite useful in the drug discovery process to determine as quickly as possible if a chemical entity possesses cytotoxic tendencies when exposed to key primary cell lines. There is a myriad of in vitro models that can be used to study the effects of a potential chemical agent on the body (e.g., using hepatocyte models for liver toxicity), and the examination systems could be used to study the effects of compounds on cellular proliferation of these model cell lines. In parallel with general proliferation assays, the examination systems may enable substantially labor-free and cost effective collection of kinetic measurements of the proliferation of in vitro cell models. In addition, these systems may provide a convenient approach to acquire multiple time point imagery from which 2 or 3-dimensional cell morphology metrics could be used to provide more detailed information on the mode of action of cytotoxic compounds.

### Example 10.

Protein Trafficking

This example describes exemplary uses of examination systems of the present teachings to perform assays of protein trafficking.

In some cases it may be useful to track the production of intracellular proteins. This can readily be accomplished using a variety of immunological and fluorescent tagging techniques. As such, examination systems with a fluorescent microscope could be used to track, follow, and quantify the production, trafficking, and/or translocation of cellular proteins over time (hours to days) with the advantage of providing multiple time point data with minimal human intervention and cost.

### Example 11.

Dilution Cloning “Scoring”

This example describes exemplary uses of examination systems of the present teachings to perform dilution cloning scoring.

The examination systems may be used for the determination of cell number in particular samples wells for the purpose of insuring that the biological sample in a given reservoir originated from a single cell. Such clonal expansion analyses may be important in the process of developing recombinant cell lines to ensure a monoclonal cell population. In the dilutional cloning method, a transfected population of cells may be dispersed into target wells at a very low density in an effort to achieve only one cell per well. Typically, an operator then must microscopically inspect the individual wells of the sample to insure that each respective sample originated from a single cell, and as such is monoclonal in origin. This process is known as “scoring.” This process is often done manually, is prone to error, and is very labor intensive. The examination systems may be used to help in the “scoring” process by imaging all the wells of a microplate, for example, and determining which of the wells contained or originated from a single cell, all without human intervention. The added advantage of the examination systems of the present teachings for this application is that the biological samples do not have to be removed from the incubator during the lengthy scoring process, thereby maintaining the integrity of the individual biological samples.

### Example 12.

Selected Embodiments

This example describes selected embodiments of the present teachings, presented as a series of numbered sentences.

1. An automated tissue-culture examination system, comprising: (A) a support for holding a biological culture sample; (B) a microscope for imaging the biological culture sample; and (C) a controller interfaced to the microscope to assess the health of the imaged sample.

2. The examination system of paragraph 1, further including a multi-dimensional microscope gantry system for imaging multiple samples or sample portions at different times.

3. The examination system of paragraph 2, wherein the microscope gantry system is packaged for integration into a standard CO₂ incubator.

4. The examination system of paragraph 1, wherein the support includes an examination tray for accepting common cell culture containers.

5. The examination system of paragraph 4, wherein the containers include petri dishes, flasks or microplates.

6. The examination system of paragraph 1, wherein the microscope includes a phase-contrast microscope and camera system.

7. The examination system of paragraph 1, wherein the microscope features an image resolution on the order of 0.5 to 2 um.

8. The examination system of paragraph 1, further including an image-based z-dimension microscope autofocusing mechanism.

The disclosure set forth above may encompass one or more distinct inventions, with independent utility. Each of these inventions has been disclosed in its preferred form(s). These preferred forms, including the specific embodiments thereof as disclosed and illustrated herein, are not intended to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

1. A system for examination of biological samples in an environmental control apparatus defining a chamber, comprising:
a sample reader configured to be received in the chamber and including a sample support, a detection mechanism, and a drive mechanism configured to drive relative movement of the sample support and the detection mechanism; and
a controller configured to control operation of the drive mechanism and the detection mechanism so that biological samples held by the sample support are examined automatically.

2. The system of claim 1, the environmental control apparatus being a tissue culture incubator configured to control temperature and carbon dioxide concentration in the chamber, the biological samples being cells, wherein the sample support is configured to hold a plurality of vessels for containing the cells.

3. The system of claim 1, the environmental control apparatus including a plurality of shelves disposed in the chamber, wherein the sample reader is configured to be supported by a single one of the shelves.

4. The system of claim 1, each of the chamber and the sample reader having a vertical height, wherein the vertical height of the chamber is at least about twice the vertical height of the sample reader.

5. The system of claim 1, wherein the sample support is slidable between an extended position for receiving vessels holding the biological samples and a retracted position in which the biological samples can be sensed by the detection mechanism.

6. The system of claim 1, wherein the drive mechanism is configured to move the detection mechanism to positions aligned with the biological samples as the sample support remains stationary.

7. The system of claim 6, wherein the detection mechanism is configured to image the biological samples, and wherein the detection mechanism includes an objective that is movable automatically along three orthogonal axes.

8. The system of claim 7, wherein the detection mechanism includes optics configured to facilitate imaging by at least one of phase-contrast, differential interference contrast, brightfield, darkfield, and fluorescence microscopy.

9. The system of claim 1, wherein the controller is configured to control automatic focusing of the detection mechanism on each biological sample.

10. The system of claim 1, wherein the controller is configured to receive a command sent over a wide area network and to implement the command to regulate operation of the sample reader.

11. The system of claim 1, wherein the controller is configured to direct repeated examination of the biological samples at predefined times.

12. A system for examination of biological samples, comprising:
a sample reader including a sample support configured to receive a plurality of vessels containing the biological samples and also including an imaging mechanism and a drive mechanism that can drive movement of at least a portion of the imaging mechanism along two or more orthogonal axes to image each of the biological samples; and
a controller configured to control operation of the drive mechanism and the imaging mechanism so that images of the biological samples are acquired sequentially.

13. The system of claim 12, wherein the sample reader has an average height, and wherein the average height is less than about twelve inches.

14. The system of claim 12, wherein the detection mechanism includes a light source and a sensor assembly, wherein the light source has a light outlet configured to send light to the biological samples and the sensor mechanism has a light inlet configured to receive light from the biological samples, and wherein movement of the light outlet and the light inlet is coupled.

15. The system of claim 14, wherein horizontal positions of the light outlet and the light inlet along at least one axis are adjustable independently.

16. The system of claim 15, wherein the drive mechanism includes a pair of belts, wherein the light source and the sensor assembly are secured to the pair of the belts, and wherein a longitudinal position of at least one of the light source and sensor assembly along the pair of belts is adjustable independently while the at least one light source and sensor assembly remains secured to the belts and the belts remain at least substantially stationary.

17. The system of claim 12, wherein the detection mechanism defines an optical path, and wherein the optical path bends a total of greater than about 180 degrees from linear.

18. A system for examination of biological samples, comprising:
a sample reader; and
a controller configured to control operation of the sample reader so that the sample reader examines biological samples automatically, the controller also being configured to be connected to a wide area network for interaction with users through a graphical user interface by any of a plurality of remote computing devices so that the users can at least one of (1) configure operation of the sample reader remotely and (2) remotely receive sample data from automatic examination of the biological samples.

19. The system of claim 18, wherein the controller is configured to permit users to receive the sample data, and wherein the controller is configured to send the sample data only to users that are authorized.

20. The system of claim 18, wherein the sample reader is configured to hold an arrangement of vessels holding the biological samples, and wherein the controller is configured to send a graphical representation of the arrangement to the remote computing devices.

21. The system of claim 20, wherein the controller is configured so that the users can select a plurality of regions within each vessel for automatic examination.

22. The system of claim 18, wherein the controller is configured so that the users can select times at which automatic examination of the biological samples will be performed.

23. A method of examining cells, comprising:
disposing cells in a plurality of vessels;
placing the vessels in a chamber having a regulated gas composition; and
imaging the cells in each vessel automatically in the chamber.

24. The method of claim 23, wherein the step of disposing including a step of introducing live cells into at least one of flasks, dishes, and microplates.

25. The method of claim 23, wherein the step of placing includes a step of locating the vessels in an incubator defining the chamber, and wherein the incubator is configured to regulate carbon dioxide concentration in the chamber.

26. The method of claim 23, wherein the step of placing the vessels includes a step of receiving the vessels with a sample support of a sample reader disposed in the chamber.

27. The method of claim 23, wherein the step of imaging is performed repeatedly at predefined times.

28. The method of claim 23, further comprising receiving one or more commands sent over a wide area network, and wherein the one or more commands automatically regulate one or more aspects of the step of imaging.

29. The method of 28, wherein the one or more commands select at least one of a time and a vessel region at which the step of imaging is performed.

30. A method of scanning biological samples, comprising:
selecting a set of biological samples disposed in one or more vessels;
receiving one or more commands sent over a wide area network; and
implementing the one or more commands automatically so that the set of biological samples is examined automatically according to the one or more commands.
